(19) United States
(12) Patent Application Publication
(10) Pub. No.: US 2002/0139680 A1
(43) Pub. Date: Oct. 3, 2002

(54) Method of fabricating a monolayer abrasive tool

(76) Inventor: Kosta Louis George, Southbridge, MA (US)

Correspondence Address: John J. Daniels, Esq., 511 Foot Hills Road, Higganum, CT, 06441, US

(21) Appl. No.: 10/109,144

(22) Filed: Mar. 27, 2002

Related U.S. Application Data
(60) Provisional application No. 60/281,135, filed on Apr. 3, 2001.

(51) Int. Cl. B32B 15/01; C25D 15/00; C03C 27/04; C25D 1/00

(52) U.S. Cl. 205/110; 428/614; 428/612; 428/634; 428/673; 428/680; 428/935; 205/183

(57) ABSTRACT

A method for fabricating an abrasive tool. A tool substrate is provided. A surface of the substrate is coated with an electroplatable bonding material. The electroplatable bonding material comprises a mixture of a conductive material and an adhesive material. Abrasive particles are adhered to the bonding material. The abrasive particles are adhered so as to have a predetermined distribution over the coated surface of the substrate. A metal layer is electroplated to the electroplatable bonding material to secure the abrasive particles to the substrate. Thus, in accordance with the present invention, the fabricated abrasive tool has abrasive particles having the predetermine distribution and fixed to the substrate by the adhesive material and the electroplated metal layer.

### CROSS REFERENCE TO RELATED APPLICATIONS

This is the US Utility Application of a Provisional Application Serial No. 60,281,135, filed Apr. 3, 2001, entitled Strategic Placement and Plating of Abrasive Particle in a Monolayer for Abrasive Tools.

### BACKGROUND OF THE INVENTION

The present invention pertains to a method of making a monolayer abrasive tool. More particularly, the present invention pertains to a method of making a monolayer abrasive tool having a predetermined spacing and concentration of abrasive particles.

The manufacturing of abrasive tools employing a monolayer of superabrasive particles is a relatively old art. The first monolayer tools date back to the turn of the century. Superabrasives are understood by those skills in the art to mean synthetic or natural diamond, cubic boron nitride and any similar very hard abrasive materials.

Historically, the first monolayer abrasive tools were made by entrapping a mixture of diamond particles and beeswax. The mixture was placed in a thin chiseled, angled slot and an upper thin steel lip was rolled over the entrapped mixture in the steel substrate.

Traditional monolayer abrasive tools used in the market place were primarily of electroplate fabrication again utilizing mechanical entrapment of the abrasive particles (see FIG. 5). A shown, in accordance with the prior art abrasive particles 10 are secured the surface of a tool substrate 12 by a metal layer 14 electroplated to the tool substrate. In the late 1960's molecular (brazed) tools were successfully fabricated and introduced to the market place. The brazed process bonding diamond to a tool substrate using a hard, high strength alloy. In the early 1970's, U.S. Pat. No. 3,894,673 was issued.

Since then a lower temperature material with good strength was sought to reduce the premature fractures and structural break down of some particles caused by the high temperature and significant difference in coefficient of thermal expansion between the diamond and the alloy which introduces certain stresses upon the diamond crystals. In the mid 90's U.S. Pat. No. 5,492,771 was issued. The patent teaches the use of a silver/copper brazed alloy with titanium content for wetting to braze a monolayer of superabrasive particles including cubic boron nitride to avoid the fracturing and breakdown of the abrasive particles.

Conventional plated tools typically have a high concentration of abrasive particles resulting in high bearing (friction) pressure, poor chip and swarf evacuation and the tendency to run hot.

Abrasive tools formed by a brazing process, as shown in FIG. 6, have abrasive particles 10 adhered to the tool substrate 12 by a brazing material 16. These tools have the additional problem of splattered brazing material 18 adhering to the cutting surface of the abrasive particles. High temperature brazed products have better chip and swarf evacuation, but they also have particle fracture and physical diamond break down as well as other problems consistent with conventional plated tools, such as high bearing (friction) pressure. Low temperature brazed products have much of the same adverse effect as the high temperature brazed products with the exception of particle break down. This process has the added problem of metal smearing and particle pull out caused by hot running tools with the low temperature brazed metal.

A high temperature brazed abrasive tool is taught in U.S. Pat. No. 3,894,673. This patent teaches strategically spacing abrasive particles but includes the drawbacks of the high temperature used in brazing, premature fracturing and physical breakdown of some particles. Aa shown in FIG. 6, other problems with this tool include the braze material 18 being occasionally brazed on some particles and the metal side build up around all abrasive particles of up to 75-80% of the particle diameter.

A lower temperature brazing process is taught in U.S. Pat. No. 5,492,771 and the fracture and physical break down of some particles may be eliminated. However, the braze metal side build up is not. Also the lower temperature product has a lower strength of hardness and temperature resistance which causes abrasive particles to dislodge and/or the braze metal melt causing smearing over the abrasive particles.

There have been prior attempts to improve upon existing technologies for monolayer abrasive tool fabrication. These attempts have failed to adequately provide a commercially satisfactory abrasive tool having a monolayer of superabrasive particles. Such a tool would be useful for a wide variety of abrasive applications that require cooler running tools for higher productivity and surface quality.

### SUMMARY OF THE INVENTION

It is an object of the present invention to overcome the drawbacks of the prior art. In accordance with the present invention, a nickel plating is applied to a monolayer of abrasive particles adhered to a substrate for abrasive tool manufacturing using a process which provides for strategically placing diamonds-much like molecularly (brazed) products. An epoxy formulation product 6020HV obtained from Metech, Inc. containing silver powder is the preferred adhesive.

In accordance with the present invention, a monolayer abrasive tool is fabricated that will maintain structurally sound abrasive particles and allow chip and swarf clearance to increase productivity and quality. In accordance with the present invention, a conventional nickel plating process is utilized to form an abrasive tool having a control concentration of abrasive particles. The present invention reduces bearing pressure and overcomes the limitations of chip and swarf clearance, which conventionally resulted in hotter running tools that, for example, will melt plastic material.

The resulting strategically plated tools have exhibited remarkable operating characteristics while controlling the particle concentration, tools made with the present invention, run cooler, quieter, and faster producing high productivity and quality. It should be noted, with this invention, jigs, fixtures and initial particle tacking is eliminated. Also the consumption of diamond in fabricating an abrasive tool is reduced.

In accordance with the present invention, a method for fabricating an abrasive tool is provided. The steps of the inventive method include providing a tool substrate. A surface of the substrate with an electroplatable bonding material. The electroplatable bonding material comprises a mixture of a conductive material and an adhesive material. Abrasive particles are adhered to the bonding material. The abrasive particles are adhered so as to have a predetermined distribution over the coated surface of the substrate. A metal layer is electroplated to the electroplatable bonding material to secure the abrasive particles to the substrate. Thus, in accordance with the present invention, the fabricated abrasive tool has abrasive particles having the predetermine distribution and fixed to the substrate by the adhesive material and the electroplated metal layer.

In accordance with a preferred embodiment of the present invention, the adhesive material comprises an epoxy. The electroplatable bonding material is cured after adhering the abrasive particles to the bonding material. The curing of the electroplatable bonding material comprises the steps of drying the bonding material at a temperature within a range of 60 through 100 degrees centigrade and then curing the dried bonding material at a temperature within a range of 150 through 200 degrees centigrade. The electroplated metal layer may comprise a nickel alloy.

Further, in accordance with the present invention an abrasive tool is provided. The inventive abrasive tool includes a substrate with an electroplatable bonding material applied to a surface of the substrate. The electroplatable bonding material comprising a mixture of a conductive material and an adhesive material. Abrasive particles are adhered to the boding material. The abrasive particles are adhered so as to have a predetermined distribution over the coated surface of the substrate. A metal layer is electroplated to the electroplatable bonding material to secure the abrasive particles to the substrate. The inventive abrasive tool thus has abrasive particles having the predetermine distribution and fixed to the substrate by the adhesive material and the electroplated metal layer.

### BRIEF DESCRIPTION OF THE DRAWINGS

FIG. 1 is a cross section of an abrasive tool fabricated in accordance with the present invention;

FIG. 2 is a flowchart showing the steps of the inventive method for fabricating an abrasive tool;

FIG. 3 is a flowchart showing more detailed steps of the inventive method for fabricating an abrasive tool;

FIG. 4 is a depication of the manufacturing steps of the inventive method for fabricating an abrasive tool;

FIG. 5 is a cross section of a prior art monolayer abrasive tool; and

FIG. 6 is a cross section of another prior art monolayer abrasive tool.

### DETAILED DESCRIPTION OF THE INVENTION

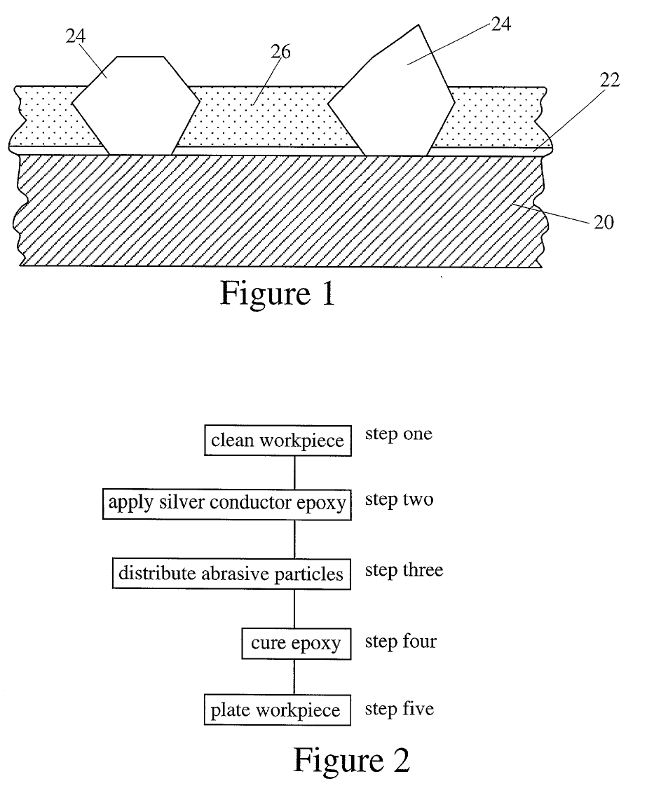

FIG. 1 is a cross section of an abrasive tool fabricated in accordance with the present invention. The inventive abrasive tool includes a substrate 20 with an electroplatable bonding material 22 applied to a surface of the substrate. The electroplatable bonding material 22 comprising a mixture of a conductive material and an adhesive material. Abrasive particles 24 are adhered to the boding material. The abrasive particles 24 are adhered so as to have a predetermined distribution over the coated surface of the substrate. A metal layer 26 is electroplated to the electroplatable bonding material 22 to secure the abrasive particles 24 to the substrate 20. The inventive abrasive tool thus has abrasive particles 24 having the predetermine distribution and fixed to the substrate 20 by the adhesive material of the bonding layer 22 and the electroplated metal layer 26.

The inventive method for making an electroplated tool if effective for strategically controlling the concentration of abrasive particles to be entrapped by, for example, a nickel alloy electroplated metal layer 26. The ability to control the spacing of the abrasive particles 24 include applying a bonding layer of silver conductor and one part latent cure epoxy to a steel substrate. Then a mono layer of superabrasive crystals of desired spacing is adhered to the bonding layer 22. The bonding layer 22 is allowed to stand for 5-10 minutes at ambient conditions following application. A two step drying/curing procedure is followed. This assembly is then conventionally nickel plated.

The present invention relates generally to methods of manufacturing monolayer superabrasive tools. Particularly to a novel and improved method of nickel plating a monolayer of superabrasive particles to a variety of abrasive configurations when controlling the particle concentration and distribution with the discovery of a silver conductor epoxy adhesive having excellent adhesion to many substrate compositions. The cured adhesive is then ready for plating using conventional electrolytic procedures.

As shown in FIG. 2, in accordance with the present invention, a method for fabricating an abrasive tool is provided. The steps of the inventive method include providing a tool substrate (step 1). A surface of the substrate is coated with an electroplatable bonding material (step 2). The electroplatable bonding material comprises a mixture of a conductive material and an adhesive material. Abrasive particles are adhered to the bonding material. The abrasive particles are adhered so as to have a predetermined distribution over the coated surface of the substrate (step 3). The bonding layer is allowed to cure (step 4). A metal layer is electroplated to the electroplatable bonding material to secure the abrasive particles to the substrate (step 5). Thus, in accordance with the present invention, the fabricated abrasive tool has abrasive particles having the predetermine distribution and fixed to the substrate by the adhesive material and the electroplated metal layer.

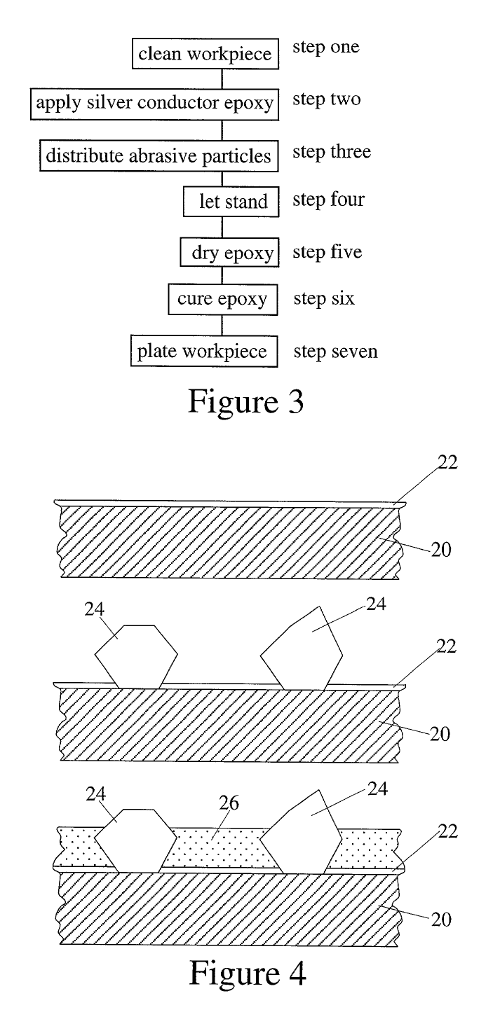

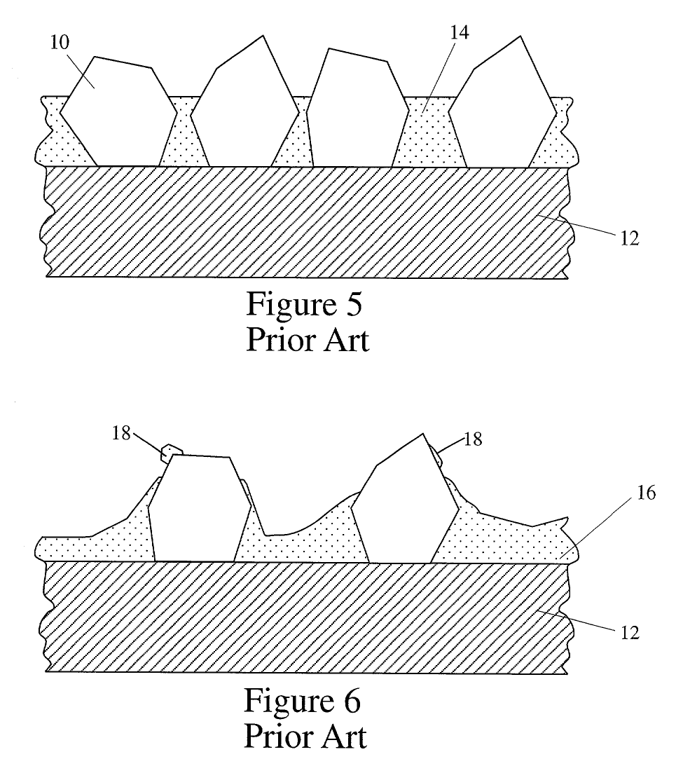

It has long been known that some of the adverse effects of a conventional electrolytic plating formed abrasive tool is that it does not have near enough chip evacuation and the tool exhibits high bearing pressure caused by high abrasive concentration. The present invention overcomes these drawbacks. As shown in FIG. 3, the inventive method for fabricating a monolayer of superabrasive particles for making an abrasive tool comprises the following steps: Degreasing/cleaning of the tool substrate or blanks (step 1). Applying a bonding layer on the substrate the bonding layer including, for example a layer of silver conductor and one part latent cure epoxy which can be purchased from Metech as silver conductor 6020HV (step 2). Placing a distribution of superabrasive particles having a desired spacing and concentration (step 3). Allowing t o stand for 5-10 minutes at ambient condition following application (step 4). A two step drying/curing procedure includes drying the part to remove solvent at 60-100° C. for approximately 10-15 minutes (step 5), and then curing at 150-200° C. for 30 minutes or more (step 6). Optimum cure schedule depends on many factors including part mass and final end use and is best determined experimentally. A conventional electrolytic nickel plating procedure is performed for plating a nickel bond thickness until between 60 and 70% of the average diameter of the superabrasive crystal (step 7).

FIG. 4 shows the manufacturing steps of the inventive method for fabricating an abrasive tool. As shown in the first drawing image, a tool substrate 20 is provided and coated with an electroplatable bonding material 22. Next, as shown in the second drawing image, abrasive particles 24 are adhered to the bonding material 22 having a predetermined distribution. As shown in the third drawing image, a metal layer 26 is electroplated to the electroplatable bonding material 22 to fix the abrasive particles 24 to the substrate 20.

The step of providing a substrate may include providing an metal substrate having a shape suitable for use as an abrasive tool, such as in the shape of a wheel or any suitable abrasive tool shape. The electroplatable bonding material 22 may comprise a mixture of a conductive material and an adhesive material. The conductive material may include silver and the adhesive material may comprise an epoxy. The electroplatable bonding material 22 is cured after adhering the abrasive particles 24 to the bonding material 22. The electroplated metal layer may comprise a nickel alloy. Thus, in accordance with the present invention the distribution of abrasive particles may be accurately controlled to form an abrasive cutting tool having superior cutting and wear characteristics as compared with the conventional art.

1) A method for fabricating an abrasive tool, comprising the steps of: providing a substrate; coating a surface of the substrate with an electroplatable bonding material; adhering abrasive particles to the bonding material having a predetermined distribution; and electroplating a metal layer to the electroplatable bonding material to fix the abrasive particles to the substrate.

2) A method for fabricating an abrasive tool according to claim 1; wherein the step of providing a substrate comprises providing an metal substrate having a shape suitable for use as an abrasive tool.

3) A method for fabricating an abrasive tool according to claim 2; wherein the shape of the metal substrate is a wheel.

4) A method for fabricating an abrasive tool according to claim 1; wherein the electroplatable bonding material comprises a mixture of a conductive material and an adhesive material.

5) A method for fabricating an abrasive tool according to claim 4; wherein the conductive material includes silver.

6) A method for fabricating an abrasive tool according to claim 4; wherein the adhesive material comprises an epoxy.

7) A method for fabricating an abrasive tool according to claim 1; further comprising the step of curing the electroplatable bonding material after adhering the abrasive particles to the bonding material.

8) A method for fabricating an abrasive tool according to claim 7; wherein the electroplatable bonding material comprises a conductive material and an epoxy; and wherein step of curing the electroplatable bonding material comprises the steps of drying the bonding material at a temperature within a range of 60 through 100 degrees centigrade and then curing the dried bonding material at a temperature within a range of 150 through 200 degrees centigrade.

9) A method for fabricating an abrasive tool according to claim 1; wherein the step of adhering abrasive particles comprises adhering abrasive particles have a predetermined distribution over the coated surface of the substrate so that the fabricated abrasive tool has abrasive particles having the predetermine distribution and fixed to the substrate by the coated bonding material and the electroplated metal layer.

10) A method of fabricating an abrasive tool according to claim 1; where the electroplated metal layer comprises a nickel alloy.

11) A method for fabricating an abrasive tool, comprising the steps of: providing a substrate; coating a surface of the substrate with an electroplatable bonding material, the electroplatable bonding material comprising a mixture of a conductive material and an adhesive material; adhering abrasive particles to the bonding material, the abrasive particles being adhered so as to have a predetermined distribution over the coated surface of the substrate; and electroplating a metal layer to the electroplatable bonding material to secure the abrasive particles to the substrate so that the fabricated abrasive tool has abrasive particles having the predetermine distribution and fixed to the substrate by the adhesive material and the electroplated metal layer.

12) A method for fabricating an abrasive tool according to claim 11; wherein the adhesive material comprises an epoxy.

13) A method for fabricating an abrasive tool according to claim 11; further comprising the step of curing the electroplatable bonding material after adhering the abrasive particles to the bonding material.

14) A method for fabricating an abrasive tool according to claim 13; wherein the electroplatable bonding material comprises a conductive material and an epoxy; and wherein step of curing the electroplatable bonding material comprises the steps of drying the bonding material at a temperature within a range of 60 through 100 degrees centigrade and then curing the dried bonding material at a temperature within a range of 150 through 200 degrees centigrade.

15) A method of fabricating an abrasive tool according to claim 11; where the electroplated metal layer comprises a nickel alloy.

16) An abrasive tool, comprising; a substrate; an electroplatable bonding material applied to a surface of the substrate, the electroplatable bonding material comprising a mixture of a conductive material and an adhesive material; abrasive particles adhered to the boding material, the abrasive particles being adhered so as to have a predetermined distribution over the coated surface of the substrate; and a metal layer electroplated to the electroplatable bonding material to secure the abrasive particles to the substrate so that the abrasive tool has abrasive particles having the predetermine distribution and fixed to the substrate by the adhesive material and the electroplated metal layer.

17) An abrasive tool according to claim 16; wherein the adhesive material comprises an epoxy.

18) An abrasive tool according to claim 16; wherein the electroplated metal layer comprises a nickel alloy.

19) An abrasive tool according to claim 16; wherein the conductive material includes silver.
